(19) United States
(12) Patent Application Publication
(10) Pub. No.: US 2003/0155888 A1
(43) Pub. Date: Aug. 21, 2003

(54) Uninterruptable lighting device with its supervisory function thereof

(75) Inventor: Mao-Tong Lien, Taipei (TW)

Correspondence Address: Johnson & Associates, 14625 Baltimore Avenue #282, Laurel, MD, 20707, US

(73) Assignee: Powercom Corporation Limited

(21) Appl. No.: 10/154,844

(22) Filed: May 28, 2002

(30) Foreign Application Priority Data
Feb. 19, 2002 (TW) 91201965

(51) Int. Cl. H02J 7/00

(52) U.S. Cl. 320/107

(57) ABSTRACT

An uninterruptable lighting device with its supervisory function thereof comprises: a detachable charging base and a portable lighting body, both furnished with a charging recepticle located at its rear and front end respectively, said charging base consists of a power supply monitor circuit and a charging status monitor circuit, said circuits further includes a first indicator and a second indicator, both located at the rear ends of said charging base respectively, and said portable lighting body consists of a car charging monitor circuit, a third indicator, a regulator, a combination switch, a lantern lighting circuit, an emergency lighting circuit, a comparator for selecting lantern lighting or emergency lighting, a battery, a battery operation status monitor circuit, a fourth indicator, and a digital clock power supply.

### BACKGROUND OF INVENTION

1. Field of the Invention

The present invention relates to an uninterruptable lighting device with its supervisory functions thereof, which provides both home charging and car cigarette lighter charging modes (car charging modes hereinafter) to enhance mobility of the lighting device, and with built-in supervisory functions. it is capable to indicate/detect the battery charging/operation status, such as home charging mode, car charging mode, battery charging and operation status. In addition, the present invention has also furnished with a combination switch for selecting emergency or lantern lighting.

2. Description of Related Art

There are a few types of chargeable flashlight available in commercial, but they are also in lack of certain functions, which user normally needs it when carries along such chargeable lighting device to remote site, for intance, it is inconvenient to charge the lighting device at distance from home, or user might from time to time worry about when it is going to be out of battery from time to time, and when charging battery is in the process, user has no idea of what battery charging status is, and in all these regards, user might found it is inconvenient to carry such chargeable flashlight along to remote site for works.

Therefore, there is a desire to have an uninterruptable lighting device thereof to mitigate and/or obviate the aforementioned problems.

### SUMMARY OF INVENTION

The object of the present invention is to provide an uninterruptable lighting device with its supervisory function thereof, which provides mobility of flashlight having supervisory functions to monitor the statuses of its operation.

To achieve the object, the uninterruptable lighting device with its supervisory function thereof comprises: a detachable charging base and a portable lighting body, both furnished with a charging receptacle located at its rear and front end respectively, said charging base consists of a power supply monitor circuit and a car charging status monitor circuit, said power supply monitor circuits further includes a first indicator and a second indicator, both located at the rear ends of said charging base respectively, and said portable lighting body consists of a car charging monitor circuit, a third indicator, a regulator, a combination switch, a lantern lighting circuit, an emergency lighting circuit, a comparator for selecting lantern lighting or emergency lighting, a battery set, a battery operation status monitor circuit, a fourth indicator, and a digital clock power supply.

One aspect of the uninterruptable lighting device with its supervisory function of the present invention is the function of a combination switch, through its combination switch position, to provide DC voltage to the first power supply terminal or the second power supply terminal, for example, when the combination switch is placed at the first position, there is no DC voltage supplied to any of the power supply terminals, when the combination switch is placed at the second position, a DC voltage is supplied to the first power supply terminal, and meanwhile if the comparator detected that the charging power supply does'nt exist, the emergency lighting circuit will turn on; when the combination switch is placed at the third position, a DC voltage is supplied to the second power supply terminal, and meanwhile if the comparator detected that the charging power supply does'nt exist, the lantern lighting circuit will turn on; on the contrary, If the charging power supply does exist, in any circumstances, both lighting circuits will not turn on.

Another aspect of the uninterruptable lighting device with its supervisory function of the present invention is that the charging base is furnished with a power supply monitor circuit and a battery charging status monitor circuit, when the charging power supply exists, the second indicator turns on, and during the period of charging, the first indicator turns on, and when the battery voltage reachs its rated voltage, the first indicator turns off. In addition, the lighting body is also furnished with a car charging monitor circuit, when the car charging power supply exists, the third indicator turns on. Furthermore, a 12VDC voltage is always connected to the battery operation status monitor circuit, when the battery voltage dropped below the level of the threshold voltage a fourth indicator turned on.

Other objects, advantages, and features of the invention will become more apparent from the following detailed description when in conjunction with the accompanying drawings.

### BRIEF DESCRIPTION OF DRAWINGS

FIG. 1 is a block diagram showing the components of the uninterruptable lighting device in accordance with the present invention;

FIG. 2 is a circuit diagram showing the preferred embodiment of the uninterruptable lighting device in accordance with the present invention; and,

FIGS. 3a and 3b are side view and rear view respectively showing the preferred embodiment of the uninterruptable lighting device in accordance with the present invention.

### DETAILED DESCRIPTION

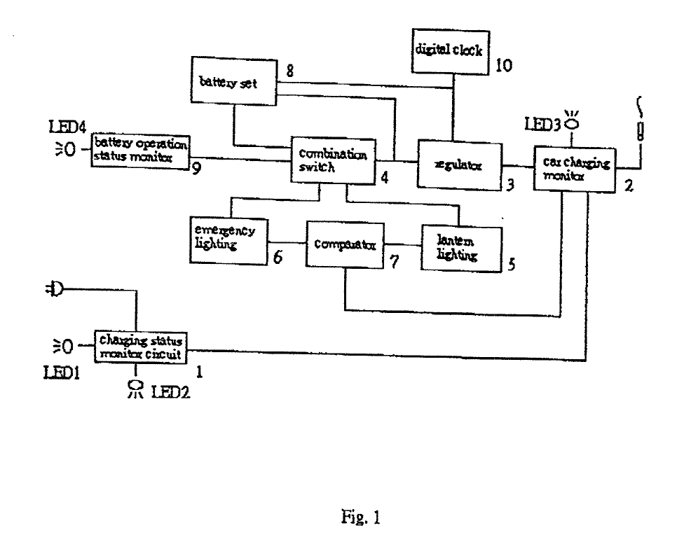

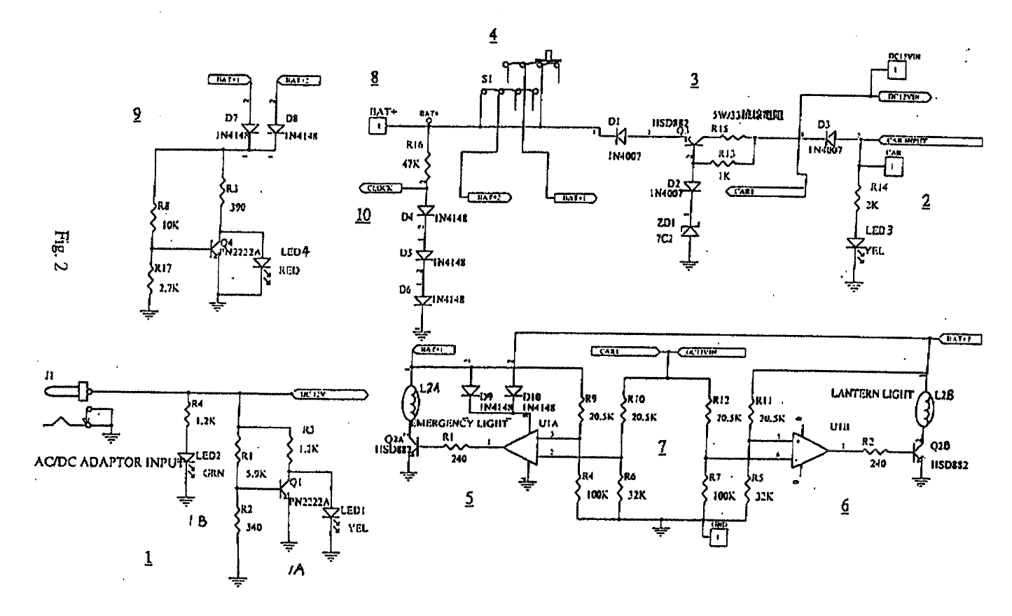

In prior to the detailed description, the block numbers and its representations are listed below for the purpose of better cross references in between FIG. 1 and FIG. 2.

block 1—charging status monitor circuit, block 2—car charging monitor circuit, block 3—regulator, block 4—combination switch, block 5—lantern lighting circuit, block 6—emergency lighting circuit, block 7—comparator, block 8—battery set, block 9—battery operation status monitor circuit, and block 10—digital clock.

FIG. 1 shows the components of the uninterruptable lighting device with its supervisory function in accordance with the present invention. Referred to the charging status monitor circuit, block 1, which is installed in the charging base of the present invention, when there is a main input, through a DC adaptor to provide a nominal 12VDC output, the LED2 turns on, meanwhile if the battery set, block 8, is in charging mode, the LED1 turns on to indicate that the battery set is charging through the main or a car cigarette lighter power supply (car power supply hereinafter), and when the battery set is fully charged, the LED1 turns off.

Referred to block 2, the car charging monitor circuit, when it is in car charging mode, the LED 3 turns on, no matter whether it is in car charging mode or main power supply charging mode, the voltage is regulated by a regulator, block 3, and outputs to the digital clock, block 10, and the battery set, block 8, respectively.

The operation of the combination switchIn, block 4, is as follows: when the combination switch is placed at the first position, a normal open position, the 12VDC power supply is supplied to the block 10 and the block 8 respectively, and when the combination switch is placed at the second position, the 12VDC power supply is supplied to the block 6, the emergency lighting circuit, meanwhile if the comparator, block 7, detects that the charging power supply does'nt exist, the emergency lighting circuit will turn on, and when the combination switch is placed at the third position, the 12VDC power supply is supplied to the lantern lighting circuit, block 5, meanwhile if the comparator, block 7, detects that the charging power supply does'nt exist, the lantern lighting circuit will turn on; on the contrary, if the comparator, block 7, detects that the charging power supply does exist, in any circumstances, both lighting circuits will not turn on. In addition, a 12VDC voltage is always connected to the battery operation status monitor circuit, block 9, when the battery voltage dropped below the level of the threshold voltage, a fourth indicator will turn on.

In order to better understand the description mentioned above, now turned to the FIG. 2. FIG. 2 is a circuit diagram showing the preferred embodiment of the uninterruptable lighting device in accordance with the present invention. In FIG. 2, there are marked with numbers 1 through 9, at the individual portion of circuits, in correspondence with the block number mentioned in FIG. 1, to provide quick cross references in between FIG. 1 and FIG. 2.

In FIG. 2, on the left lower portion marked with 1, 1A and 1B, indicates charging base 1, charging status monitor circuit 1A consisted of Q1, LED1 and other components, power supply monitor circuit 1B consisted of LED2 and other components, respectively; on the right upper portion marked with 2, indicates car charging monitor circuit 2, consisted of LED3 and other components, regulator 3 consisted of Q3, ZD1 and other components; on the center portion marked with 4, indicates a combination switch 4 (S1), the combination switch S1 is adapted for connecting the 12VDC power supply to the first power supply terminal BAT1 and the second power supply terminal BAT2, on its left side is the electronic digital clock power supply 10 consisted of diodes 4-6 and other coponents; on the right lower portion marked with 5, 6 and 7, indicates emergency lighting circuit 5 consisted of Q2B, L2B and other components, comparator circuit 6 consisted of Q2A, L2A and other components and lantern lighting circuit 7 consisted of U1A and U1B, voltage divider and other components, respectively; on the upper left portion marked with 8 and 9, indicates battery set 8 and its threshhold voltage level monitor circuit 9 consisted of Q4, LED4 and other components, respectively. The rest of circuits on the FIG. 2 not mentioned above are seen as conventional and would not be described here.

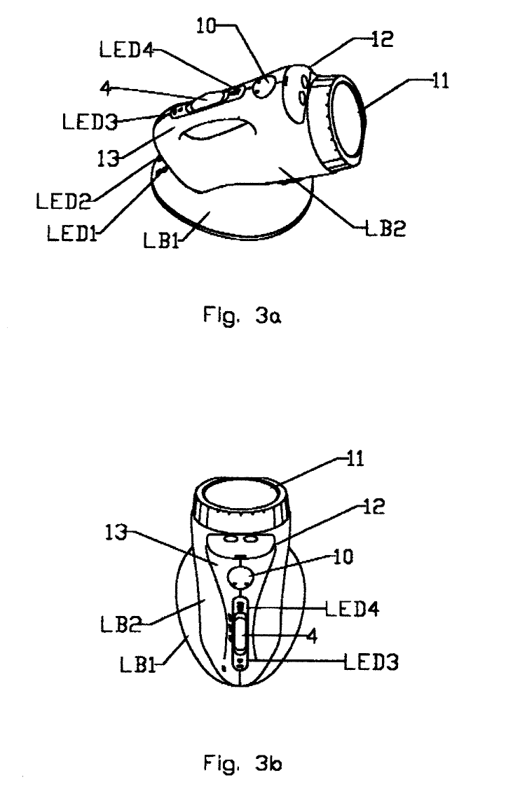

FIGS. 3a and 3b are side view and rear view respectively showing the preferred embodiment of the uninterruptable lighting device in accordance with the present invention. In FIG. 3a, a portable lantern lighting 11 is located at the right front end of the portable lighting body LB2, a emergency lighting 12 is located above the lantern lighting 11 near its rim, an electronic digital clock 10 is located in front of the handle of the portable lighting body 13, a battery set 8 monitor indicator LED4 is located on the top of handle of the portable lighting body 13 nearby the electronic digital clock 10, a car power supply charging monitor indicator LED3 is located on the top of handle of the portable lighting body 13 at the other end to the indicator LED4, a power supply monitor indicator LED2 is located at the rear end of the lighting base LB1, and a battery set 8 charging status monitor indicator LED1 is located at the rear end of the charging base LB1 juxtaposed with LED2. FIG. 3b used the identical reference numbers to indicate the similar parts as shown in FIG. 3a.

Although the present invention has been explained in relation to its preferred embodiment, it is to be understood that many other possible modification and variations can be made without departing from the sirit and scope of the invention as hereinafter claimed.

What is claimed is:

1. An uninterruptable lighting device with its supervisory function thereof comprises: a detachable charging base and a portable lighting body, both furnished with a charging recepticle located at its rear and front end respectively, said charging base consists of a power supply monitor circuit and a charging status monitor circuit, said circuits further includes a first indicator and a second indicator, both located at the rear ends of said charging base respectively, and said portable lighting body consists of a car charging monitor circuit, a third indicator, a regulator, a combination switch, a lantern lighting circuit, an emergency lighting circuit, a comparator for selecting lantern lighting or emergency lighting, a battery, a battery operation status monitor circuit, a fourth indicator, and a digital clock power supply.

2. An uninterruptable lighting device with its supervisory function as claimed in claim 1, wherein a combination switch, through its combination switch position, to provide DC voltage to the first power supply terminal or the second power supply terminal, when the combination switch is placed at the first position, there is no DC voltage supplied to any of the power supply terminals, when the combination switch is placed at the second position, a DC voltage is supplied to the first power supply terminal, and meanwhile if the comparator detected that the charging power supply does'nt exist, the emergency lighting circuit will turn on; when the combination switch is placed at the third position, a DC voltage is supplied to the second power supply terminal, and meanwhile if the comparator detects that the charging power supply does'nt exist, the lantern lighting circuit will turn on; on the contrary, If the charging power supply does exist, in any circumstances, both lighting circuits will not turn on.

3. An uninterruptable lighting device with its supervisory function as claimed in claim 1, wherein the charging base is furnished with a power supply monitor circuit and a battery charging status monitor circuit, when the charging power supply exists, the second indicator turns on, during the period of charging, the first indicator turns on, and when the battery voltage reachs its rated voltage, the first indicator turns off, furthermore, the lighting body is also furnished with a car charging monitor circuit, when the car charging power supply exists, the third indicator turns on, and a 12VDC voltage is always connected to the battery operation status monitor circuit, when the battery voltage dropped below the level of threshold voltage the fourth indicator turned on.
